(19) United States
(12) Patent Application Publication
(10) Pub. No.: US 2007/0070973 A1
(43) Pub. Date: Mar. 29, 2007

(54) Method and system for achieving alignment between a centralized base station controller (CBSC) and a base transceiver site (BTS) in a network

(76) Inventor: Zaigham A. Kazmi, Gilberts, IL (US)

Correspondence Address: MOTOROLA, INC., LAW DEPARTMENT, 1303 E. ALGONQUIN ROAD, SCHAUMBURG, IL, 60196, US

(21) Appl. No.: 11/240,176

(22) Filed: Sep. 29, 2005

(51) Int. Cl. H04J 3/06

(52) U.S. Cl. 370/350; 370/509

(57) ABSTRACT

A method and system for achieving timeframe alignment between a Centralized Base Station Controller (CBSC) (106) and a Base Transceiver Site (BTS) (102) in a network is disclosed. The BTS returns a Forward Sequence Number (FSN) contained in a forward frame and a Packet Arrival Time Error (PATE) to the CBSC. The CBSC computes a Round Trip Time (RTT), using the FSN. The CBSC also computes a forward Coordinated Universal Time (UTC), using the RTT and the PATE. Thereafter, a CBSC transmission time is adjusted to align with the BTS, based on the adjusted UTC.

### FIELD OF THE INVENTION

This invention relates in general, to radio communication networks, and more specifically, to an alignment between a Centralized Base Station Controller (CBSC) and a Base Transceiver Site (BTS) in a network.

### BACKGROUND OF THE INVENTION

In a network, such as a telecommunication network, a plurality of Base Transceiver Sites (BTS') and a Centralized Base Station Controller (CBSC) exchange data among themselves. The communication can be via optical fiber, satellite, and the like. The data related to communication is transmitted is in the form of discreet units called data packets. The data packets are encoded before transmission. An encoded data packet is called a frame. Each frame contains a parameter signifying the quality of the frame, called a Frame Quality Indicator (FQI). An FQI signifies if the frame is corrupt or not. The CBSC transmits and receives frames over a wired or a wireless link. Example of a wired link can be an optical fiber link. Example of a wireless link can be a Radio Frequency (RF) link. However, there can be a delay in reception of the frames due to congestion in the network, and the like. Due to the delay in reception, synchronization between the CBSC and the BTS gets disturbed.

The delay is high in networks that use satellite backhaul for communication purposes. Due to lack of synchronization between a BTS and a CBSC, simultaneous communication between a mobile phone and a plurality of BTS', also known as soft handoff, becomes difficult. This occurs when a particular frame is required to be sent to the plurality of BTS' simultaneously. Another problem is caused while making a standard test call, called Markov, for voice services in a CDMA network. A Markov simulator, in a CDMA network, generates data packets with different rates to simulate a voice call for a voice service. Examples of rates include a full rate, a half rate and a quarter rate. On the other hand, a receiving device in the CDMA network tries to decode the data packets. If the Markov simulator and receiving device are not synchronized, the test call fails.

There are various methods for achieving alignment between a CBSC and a BTS. In one such method, a change in a Packet Arrival Time Error (PATE) due to change in transmission time of a frame from the CBSC is monitored. A PATE is a value that indicates the time when a frame was received with respect to expected time of arrival of the frame. The method includes calculating a Round Trip Time (RTT) based the PATE. An RTT is the time between transmission of a frame from a CBSC to a BTS, known as a forward frame, and reception of a corresponding frame from the BTS, known as a reverse frame. Arrival of the reverse frame at the CBSC confirms that the BTS has received the forward frame.

In another such method, the RTT is measured using ping. Ping is a tool to test whether a BTS or a CBSC is operating properly in a network and is reachable from a test device. A test device sends data packets to the BTS or the CBSC in the network and receives the responses.

In yet another method, the upper 32 bits of a 36-bit adjusted Coordinated Universal Time (UTC) (or forward UTC) at the CBSC are set by reverse UTC and PATE feedback received from a BTS UTC (or reverse UTC) whereas the lower four bits are adjusted based on a PATE. A UTC is a 36-bit time stamp with a 20 milliseconds (ms) least count. The BTS UTC is a time stamp associated by a BTS to a reverse frame. Similarly, the adjusted UTC (or forward UTC) is a time stamp associated by a CBSC to a forward frame.

However, the methods described above suffer from one or more of the following disadvantages. The methods cannot be applied in large delay networks, where the delay is of the order of 160 ms. An example of such a large delay network can be a network using satellite backhaul for communication. Moreover, the methods may result in a false detection of the link since the PATE may change due to jitter in the network. The methods may have an error in computing the RTT due to loss of the frames during transmission, which is a possibility in satellite backhaul. Also, the methods may be intrusive as the timing of forward frames is altered. Further, the methods may lead to inaccurate adjustment in transmission time due to inaccurate computation of the delay.

### BRIEF DESCRIPTION OF THE FIGURES

Representative elements, operational features, applications and/or advantages of the present invention reside inter alias in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 represents an exemplary environment, in accordance with an exemplary embodiment of the present invention.

FIG. 2 illustrates the interaction between modules contained in a Base Transceiver Site (BTS) and a Centralized Base Station Controller (CBSC), in accordance with an exemplary embodiment of the present invention.

FIG. 3 is a flowchart illustrating a method for achieving alignment between the CBSC and the BTS in a network, in accordance with an exemplary embodiment of the present invention.

FIG. 4 is an exemplary illustration of the method of FIG. 3 for achieving alignment between the BTS and the CBSC network, in accordance with an embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention.

### DETAILED DESCRIPTION OF THE PREFERRED EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

A detailed description of an exemplary application, namely ‘achieving alignment between a Centralized Base Station Controller (CBSC) and a Base Transceiver Site (BTS) in a network’ is provided as a specific enabling disclosure that may be generalized to any application of the disclosed system, device and method for achieving alignment between a Centralized Base Station Controller (CBSC) and a Base Transceiver Site (BTS) in a network in accordance with various embodiments of the present invention.

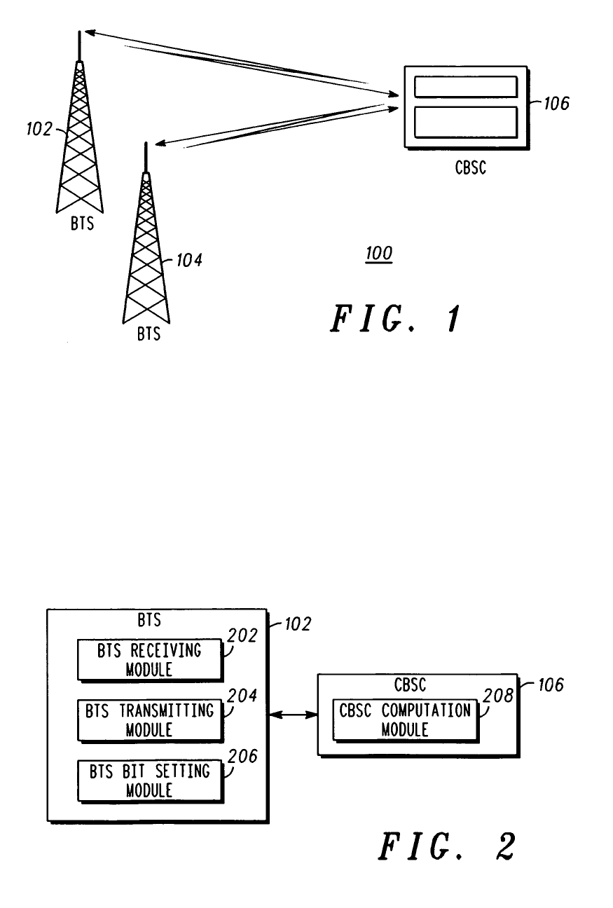

FIG. 1 represents an exemplary environment, in accordance with an exemplary embodiment of the present invention. A network 100 includes a plurality of BTSs, such as a Base Transceiver Site (BTS) 102 and a BTS 104, and a Centralized Base Station Controller (CBSC) 106. Examples of the network 100 include a Code Division Multiple Access (CDMA) network, a Global System for Mobile Communications (GSM) network, and the like. The BTS 102 receives Radio Frequency (RF) signals from a plurality of electronic devices in the network 100. Examples of an electronic device include mobile phone, smart phone, and the like. The BTS 102 communicates with the CBSC 106 via RF signals. The BTS 102 transmits frames to the CBSC 106 over a path, called a reverse link, which can be a wireless path or a wired path. A frame transmitted over the reverse link is called a reverse frame. The CBSC 106 performs functions such as call set-up, call tear down, traffic processing and hands off between the calls. Further, the CBSC 106 communicates with the BTS 102 and the BTS 104 by sending frames over a path, which is called a forward link. This forward link can be a wireless path or wired path. A frame transmitted over the forward link is called a forward frame.

FIG. 2 illustrates the interaction between modules contained in the BTS 102 and the CBSC 106, in accordance with an exemplary embodiment of the present invention. The BTS 102 includes a BTS Receiving Module 202, a BTS Transmitting Module 204 and a BTS Bit Setting Module 206. The CBSC 106 includes a CBSC Computation Module 208. The BTS Receiving Module 202 receives a forward frame with a four-bit Forward Sequence Number (FSN) over the forward link. A FSN is a number used for identifying a particular forward frame. The FSN is then sent to the BTS Transmitting Module 204. The FSN is used to calculate a PATE. A negative value of PATE indicates that a frame arrived earlier than the expected time of arrival of the frame. Conversely, a positive value of PATE indicates that a frame arrived later than the expected time of arrival of the frame. The PATE and the FSN are then reported to the CBSC 106 over the reverse link. In an embodiment of the present invention, all the frames transmitted in a CDMA network contain a PATE value.

In an embodiment of the present invention, the BTS Transmitting Module 204 sends an invalid PATE with a two-bit scaling and a six-bit field value equal to ‘100000b’ to the CBSC 106 to prevent false detection of the connection between the BTS 102 and the CBSC 106. A two-bit scaling of the invalid PATE can be one of the ‘00’, ‘01’, ‘10’ or ‘11’. The arrival of the invalid PATE at the CBSC 106 indicates the CBSC 106 not to start the computation of the RTT, thereby preventing the false detection of the connection. Thereafter, the arrival of a valid PATE, i.e., a PATE other than an invalid PATE, indicates that the BTS 102 has received a first forward frame sent by the CBSC 106. This triggers the computation of the RTT by the CBSC Computation Module 208.

In an embodiment of the present invention, the BTS Transmitting Module 204 also sends an erasure frame to the CBSC 106 as soon as the BTS 102 receives a first forward frame sent to it by the CBSC 106. An erasure frame does not contain any data related to the communication except a BTS UTC. A conventional erasure frame is a corrupt or damaged frame with a FQI value set to ‘0’. When a CBSC receives such a conventional erasure frame from an electronic device in a network, the CBSC intimates the electronic device to increase its transmission power. A BTS UTC is a time stamp given by a BTS to a reverse frame. In an embodiment of the present invention, the last four bits of the BTS UTC are set as ‘0’ (zero) when the BTS 102 has not received any forward frame by the CBSC 106. The erasure frame, sent to the CBSC 106, has a FQI value set to ‘1’ instead of ‘0’. The FQI value of ‘1’ ensures that the CBSC 106 differentiates the erasure frame from a conventional erasure frame.

Before sending the FSN and the PATE to the CBSC 106, the last four bits of a BTS UTC are set to be equal to the FSN. In an embodiment of the present invention, this is carried out by the BTS Bit Setting Module 206. For example, in a 36 bit BTS UTC represented as ‘XXXm’, ‘XXX’ represents the first 32 bits and ‘m’ represents the last four bits of the BTS UTC. Suppose that a four-bit FSN is represented by ‘n’. The BTS Bit Setting Module 206 replaces the last four bits of the BTS UTC, i.e., ‘m’, with the four-bit FSN, i.e., ‘n’, to generate a new BTS UTC as ‘XXXn’. Each frame transmitted by the BTS 102 is given a sequential time stamp, referred as the BTS UTC. The time stamps, associated with the transmitted frames, enable the CBSC 106 to identify a correct sequence of transmitted frames.

The FSN transmitted by the BTS 102 is received by the CBSC computation module 208. The CBSC Computation Module 208 computes a Round Trip Time (RTT) using the FSN received from the BTS Transmitting Module 204. The CBSC Computation Module 208 also computes an adjusted UTC (or forward UTC) by using the RTT, the BTS UTC and the PATE. The FSN of a subsequent forward frame is determined using the adjusted UTC. The CBSC 106 adjusts its transmission time to align with the BTS 102, based on the PATE.

FIG. 3 is a flowchart illustrating a method for achieving alignment between the CBSC 106 and the BTS 102 in the network 100, in accordance with an exemplary embodiment of the present invention. The BTS Receiving Module 202 receives a forward frame with an FSN over a forward link from the CBSC 106. At step 302, the FSN is returned to the CBSC 106. In an embodiment of the present invention, the BTS Transmitting Module 204 returns the FSN to the CBSC 106. The FSN is returned over a reverse link. The BTS Bit Setting Module 206 sets the last four bits of a BTS UTC to be equal to the FSN. The CBSC Computation Module 208 receives the FSN. In addition, an erasure frame is sent to the CBSC Computation Module 208. The BTS UTC is contained in the erasure frame. The structure of the reverse frame is retained while returning the FSN to the CBSC 106.

At step 304, a PATE is reported to the CBSC 106. The BTS 102 reports the PATE to the CBSC 106. In an embodiment of the present invention, the BTS Transmitting Module 204, reports the PATE to the CBSC Computation Module 208, in the erasure frame. The FQI is set to ‘1’ for the erasure frame. At step 306, an RTT is computed using the FSN at the CBSC 106. In an embodiment of the present invention, the CBSC Computation Module 208 checks the last 4 bits of the BTS UTC, to extract the FSN, as soon as the CBSC 106 receives the reverse frame. Thereafter the time when the first forward frame with the FSN was transmitted is checked. The RTT is computed as a time difference between the time of transmission of the first forward frame and a time when the reverse frame is received at the CBSC 106.

At step 308, the CBSC 106 computes an adjusted UTC by using the RTT and the PATE received in the reverse frame. A delay value is calculated, based on the RTT and the PATE. Further, the adjusted UTC is computed by adding the RTT, the BTS UTC and the delay. At the step 310, the adjusted UTC is used to determine an FSN of a subsequent forward frame to be transmitted by the CBSC 106. At the step 312, a CBSC transmission time is adjusted with the BTS 102 using the PATE.

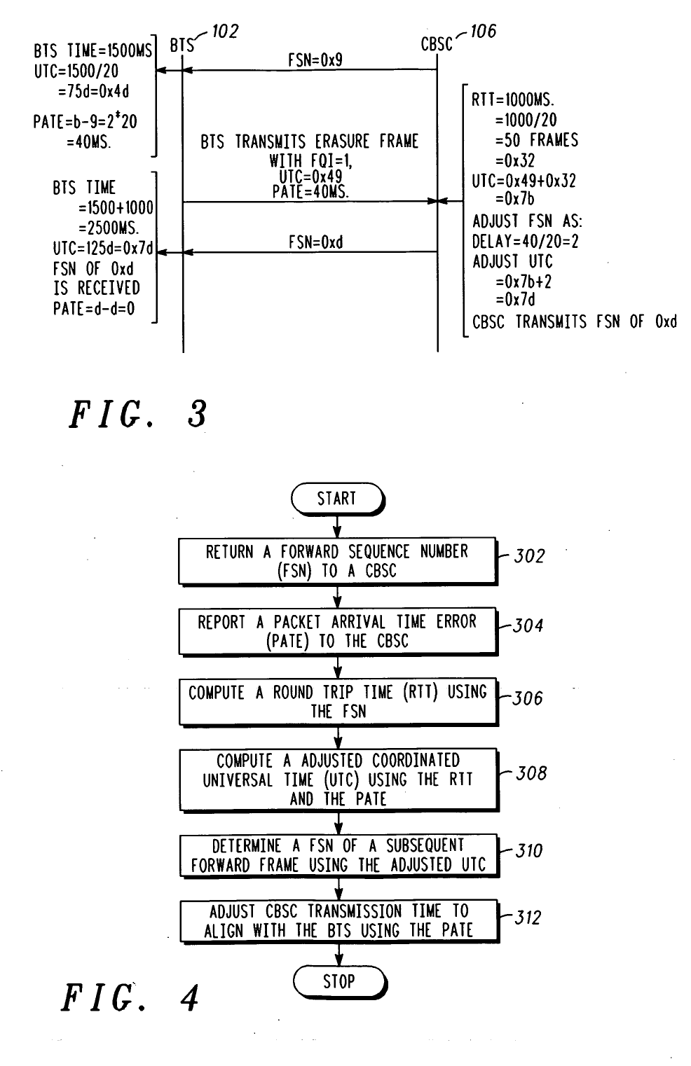

FIG. 4 represents an exemplary illustration of the method described in FIG. 3 for achieving alignment between the BTS 102 and the CBSC 106 network, in accordance with an embodiment of the present invention. Consider a BTS time to be 1500 ms. The BTS 102 calculates a UTC, based on the BTS time as 1500/20, i.e., 75, where 20 ms is the least count of the UTC. In the hexadecimal format, the UTC is represented as ‘0×4b’. The BTS 102 receives a forward frame with an FSN from the CBSC 106. Suppose that the hexadecimal representation of the FSN is ‘0×9’. The PATE is then calculated, based on the UTC and the FSN, as b-9, which is equal to 2. Since the least count of UTC is 20 ms, the value of PATE is expressed as 2*20=40 ms. The last four bits of the UTC are then replaced by the FSN, to generate a BTS UTC. In this case, the BTS UTC is given as ‘0×49’. Thereafter, an erasure frame, with FQI value ‘1’, is sent to the CBSC 106. The erasure frame contains the BTS UTC and the PATE. The CBSC 106, on receiving the erasure frame, computes the RTT. The CBSC 106 computes RTT as the time difference when it first transmitted a forward frame with FSN=0×9 and the time when it received a reverse frame from the BTS with a valid PATE and the BTS UTC with last 4 bits set to ‘0×9’. Consider a case with the RTT as 1000 ms, which is represented in hexadecimal format as ‘0×32’. A subsequent forward frame is transmitted after approximately 20 ms by the CBSC 106. Further, a UTC is computed by adding the BTS UTC and the RTT, which comes to be ‘0×7b’. A delay is then calculated by using the PATE as 40/20=2. Therefore, an adjusted UTC is computed by adding ‘0×7b’ and ‘2’, which is equal to ‘0×7d’. The adjusted UTC is used to determine a FSN of the subsequent forward frame to be transmitted by the CBSC 106. Since the adjusted UTC is ‘0×7d’, the CBSC 106 transmits the subsequent forward frame with FSN equal to ‘0×d’. The BTS time for the subsequent reverse frame becomes 1500+1000, which is equal to 2500 ms. Further, the BTS 102 calculates a UTC based on the BTS time as 2500/20, i.e., 125. In the hexadecimal format, the UTC is represented as ‘0×7d’. The BTS 102 needs to transmit a frame with FSN equal to ‘0×d’, and the BTS 102 receives the forward frame with FSN equal to ‘0×d’. Thus both the BTS 102 and the CBSC 106 are aligned.

The present invention provides a method and system for achieving alignment between a Centralized Base Station Controller (CBSC) and a Base Transceiver Site (BTS) in a network. The method and system enables an accurate alignment of transmission times of frames between the BTS 102 and the CBSC 106, even in high delay networks, such as those that use satellite backhaul.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

It will be appreciated the system described herein may be comprised of one or more conventional processors and unique stored program instructions that control the one or more processors to implement, in conjunction with certain non-processor circuits, some, most, or all of the functions of the components or modules of the system described herein. The non-processor circuits may include, but are not limited to, a radio receiver, a radio transmitter, signal drivers, clock circuits, power source circuits, and user input devices. As such, these functions may be interpreted as steps of a method for achieving alignment between a CBSC and a BTS in a network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

What is claimed is:

1. A method for achieving timeframe alignment between a Centralized Base Station Controller (CBSC) and a Base Transceiver Site (BTS) in a network, the method comprising:
returning a Forward Sequence Number (FSN) to the CBSC, the FSN being contained in a forward frame;
reporting a Packet Arrival Time Error (PATE) to the CBSC;
computing a Round Trip Time (RTT) using the FSN;
computing a adjusted Universal Time Coordinated (UTC) using the RTT and the PATE; and
adjusting a CBSC transmission time to align with the BTS.

2. The method of claim 1, wherein returning the FSN to the CBSC comprises retaining structure of the reverse frame.

3. The method of claim 1 further comprising setting the last four bits of a BTS UTC as the FSN.

4. The method of claim 1, wherein the PATE is in an erasure frame with a Frame Quality Indicator (FQI), whose value is set to one.

5. The method of claim 1, wherein the adjusted UTC is computed based on the RTT, the BTS UTC and the PATE.

6. The method of claim 1 further comprising sending an invalid PATE to the CBSC with a two-bit scaling and a six-bit value field equal to ‘100000b’.

7. The method of claim 6, wherein the two bit scaling is selected from a group comprising ‘00’, ‘01’, ‘10’ and ‘11’.

8. The method of claim 1 further comprising sending an erasure frame to the CBSC.

9. The method of claim 8, wherein the last four bits of the BTS UTC are set to zero.

10. The method of claim 8 wherein the BTS UTC is contained in the erasure frame.

11. A system for achieving alignment between a Centralized Base Station Controller (CBSC) and a Base Transceiver Site (BTS) in a network, the system comprising:
a BTS receiving module for receiving the forward frame over a forward link;
a BTS Transmitting Module for returning a Forward Sequence Number (FSN), reporting a Packet Arrival Time Error (PATE) and sending a erasure frame to the CBSC; and
a CBSC computation module for computing a Round Trip Time (RTT) and an adjusted Universal Time Coordinated (UTC).

12. The system according to claim 11 further comprising a BTS bit setting module for setting the last four bits of a BTS UTC as the FSN.

13. The system according to claim 11, wherein the CBSC computation module computes the RTT by using the FSN.

14. The system according to claim 11, wherein the CBSC computation module computes the adjusted UTC based on the RTT, the BTS UTC and the PATE.

15. A computer program product for use with a computer, the computer program product comprising a computer usable medium having a computer readable program code embodied therein, for achieving alignment between a Centralized Base Station Controller (CBSC) and a Base Transceiver Site (BTS) in a network, the computer program code performing:
reporting a Packet Arrival Time Error (PATE) to the CBSC;
computing a Round Trip Time (RTT) using FSN;
computing an adjusted Universal Time Coordinated (UTC) using the RTT and the PATE; and
adjusting a CBSC transmission time to align with the BTS using the adjusted UTC, the PATE and the RTT.

16. The computer program product of claim 15, wherein the FSN is returned to the CBSC by setting last four bits of the BTC UTC to the FSN.

17. The computer program product of claim 15, wherein the PATE is contained in an erasure frame that has a Frame Quality Indicator (FQI), whose value is set to one.

18. The computer program product of claim 15, wherein the adjusted UTC is computed based on the RTT, the BTS UTC and the PATE.
